(19) United States
(12) Patent Application Publication
(10) Pub. No.: US 2023/0110808 A1
(43) Pub. Date: Apr. 13, 2023

(54) ROTOR DISCONNECT CLUTCH ASSEMBLY

(71) Applicant: Schaeffler Technologies AG & Co. KG, Herzogenaurach (DE)

(72) Inventors: Brian Lee, Charlotte, NC (US); Philip George, WOOSTER, OH (US)

(73) Assignee: Schaeffler Technologies AG & Co. KG, Herzogenaurach (DE)

(21) Appl. No.: 17/955,867

(22) Filed: Sep. 29, 2022

Related U.S. Application Data
(60) Provisional application No. 63/253,620, filed on Oct. 8, 2021.

(51) Int. Cl. H02K 7/108; H02K 7/116

(52) U.S. Cl. CPC H02K 7/108; H02K 7/116

(57) ABSTRACT

A rotor shaft disconnect clutch assembly includes a housing, a rotor supported for rotation with respect to the housing and a shaft supported for rotation with respect to the housing. An outer ring may be fixed to the rotor and have a radially inner surface. A slipper ring may be disposed radially between the outer ring and the shaft. A plurality of rollers may be disposed between the radially inner surface of the outer ring and the radially outer surface of the slipper ring that is configured to radially compress the slipper ring in response to rotational displacement of the slipper ring relative to the outer ring. An armature may be rotationally fixed to the rotor and configured to slide axially with respect to the rotor. The armature may have a feature configured to selectively engage a feature of the slipper ring to rotationally position the slipper ring with respect to the outer ring. A solenoid may be fixed to the housing and configured to selectively exert an axial force on the armature.

### CROSS-REFERENCE TO RELATED APPLICATION

This application claims the benefit of U.S. Provisional Patent Application No. 63/253,620, filed Oct. 8, 2021, the disclosure of which is incorporated in its entirety by reference herein.

### TECHNICAL FIELD

The present disclosure relates generally to a rotor shaft disconnect clutch assembly for an electric axle.

### BACKGROUND

FIG. 1 schematically illustrates an example of a two-motor electric axle drive 10. The electric axle may have two operating modes. In a first operating mode, the two motors act independently each driving one of the two wheels. In a second operating mode, the two wheels are coupled to rotate at the same speed as one another and may be driven by either motor.

The electric axle includes two gearbox input shafts 12 and 14. Left gearbox 16 drives left wheel 18 at a fraction of the speed of left gearbox input shaft 12. The left motor includes a left stator 20 and a left rotor 22 which is fixed to the left gearbox input shaft 12. Similarly, right gearbox 24 drives right wheel 26 at a fraction of the speed of right gearbox input shaft 14. The right motor includes a right stator 28 and a right rotor 30 which is fixed to the right gearbox input shaft 14. Clutch 32 selectively couples the two gearbox input shafts to one another.

To activate the first operating mode, clutch 32 is released. The left motor drives left wheel 18 and the right motor drives right wheel 26. The speeds of the wheels may differ. The torque applied to the two wheels is controlled independently. To activate the second operating mode, clutch 32 is engaged. The speeds of the two wheels are constrained to be equal. Power from either motor is divided between the wheels but necessarily equally. If one wheel loses traction, the motor power is routed predominantly to the other wheel.

Although only one of the motors is required in the second operating mode, the second rotor will rotate with the respective gearbox input shaft. This adds parasitic losses, especially if the motor is a permanent magnet motor, which is common in many applications. Parasitic losses would be reduced substantially if the unused motor could be disconnected from the shaft. This same issue also arises in other electrified powertrain configurations. For example, if four motors are provided, one for each wheel, the vehicle may operate in a mode in which only the front wheels or only the rear wheels provide propulsion. Some vehicles utilize an electrified axle in the rear and a conventional powertrain in the front. Such vehicles may have operating modes in which the electrified axle is not used for propulsion and disconnecting the motor or motors would significantly reduce parasitic drag.

### SUMMARY

In embodiments, a rotor shaft disconnect clutch assembly includes a housing, a rotor supported for rotation with respect to the housing and a shaft supported for rotation with respect to the housing. An outer ring may be fixed to the rotor and have a radially inner surface. A slipper ring may be disposed radially between the outer ring and the shaft. A plurality of rollers may be disposed between the radially inner surface of the outer ring and the radially outer surface of the slipper ring that is configured to radially compress the slipper ring in response to rotational displacement of the slipper ring relative to the outer ring. An armature may be rotationally fixed to the rotor and configured to slide axially with respect to the rotor. The armature may have a feature configured to selectively engage a feature of the slipper ring to rotationally position the slipper ring with respect to the outer ring. A solenoid may be fixed to the housing and configured to selectively exert an axial force on the armature.

Embodiments further include that the shaft is disengaged from the outer ring and the rotor when the feature of the armature is engaged with the feature of the slipper ring. The shaft is coupled to the outer ring and the rotor when the feature of the armature is disengaged from the feature of the slipper ring allowing rotational displacement of the slipper ring relative to the outer ring. The assembly may include a spring configured to bias the armature toward the slipper ring such that the feature of the armature is engaged with the feature of the slipper ring. In response to the solenoid exerting the axial force on the armature, the armature slides axially away from the slipper ring overcoming a force exerted by the spring to disengage the feature of the armature from the feature of the slipper ring thereby coupling the shaft to the outer ring and rotor. The feature of the armature may be a protrusion, the feature of the slipper ring may be a notch, and the protrusion may be configured to selectively engage with the notch. The radially inner surface of the outer ring may be designed as a wavy contoured surface. The radially outer surface of the slipper ring may be designed as a wavy contoured surface. The rotor may be supported for rotation via first and second bearings disposed on axially opposite sides of the outer ring.

### BRIEF DESCRIPTION OF THE DRAWINGS

FIG. 1 is a schematic view of a two-motor electric axle.

FIG. 2 is a cutaway view of a rotor and shaft assembly with a disconnect clutch according to embodiments of the present disclosure.

FIG. 3 is a cross-sectional view of the rotor and shaft assembly of FIG. 2.

FIG. 4 is a pictorial view of the slipper clutch assembly of the rotor and shaft assembly of FIG. 2.

FIG. 5 is a pictorial view of the armature of the rotor and shaft assembly of FIG. 2.

FIG. 6 is a cutaway view of the slipper clutch assembly and actuator assembly of the rotor and shaft assembly of FIG. 2 in the disengaged position.

FIG. 7 is a cutaway view of the slipper clutch assembly and actuator assembly of the rotor and shaft assembly of FIG. 2 in the engaged position.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only, and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

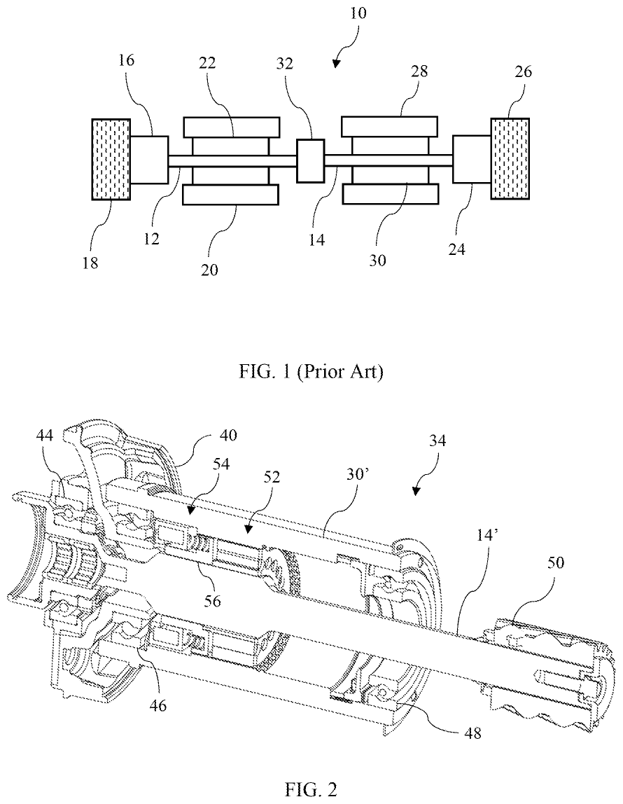

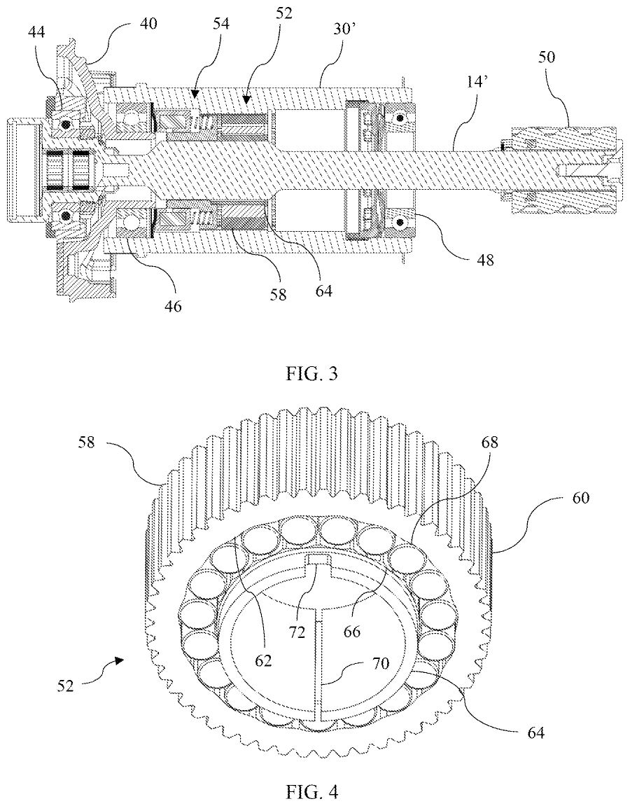

FIGS. 2-3 show a rotor disconnect unit 34 according to embodiments of the present disclosure that reduces and/or eliminates the parasitic losses of the right motor (i.e., stator 28, rotor 30) and right shaft 14 configuration of FIG. 1. According to embodiments described herein, it is possible with rotor disconnect unit 34 to disconnect shaft 14′ from rotor 30′ shown in FIGS. 2-3 unlike shaft 14 and rotor 30 shown in FIG. 1 which cannot be disconnected. The disconnect features of rotor disconnect unit 34 are also suitable for use in a variety of other electrified powertrain configurations. Referring to FIGS. 2-3, a portion of housing 40 is depicted, but other portions are omitted from these views so that other parts are more clearly visible to understand the disclosure. One end of shaft 14′ may be supported from housing 40 by bearing 44. Rotor 30′ may be supported for rotation by bearings 46 and 48. Input gear 50 may be fixed to shaft 14′ at one end. Shaft 14′ may be selectively coupled to rotor 30′ by slipper clutch assembly 52 which is described in more detail below. Slipper clutch assembly 52 may be controlled via actuator assembly 54, including armature 56, which is described in more detail below.

FIG. 4 shows the components of slipper clutch assembly 52 in more detail. This pictorial view shows the side facing toward actuator assembly 54. Slipper clutch assembly 52 includes outer ring 58 that has an outer radial surface with an external spline 60 which meshes with an internal spline of rotor 30′. Outer ring 58 includes inner radial surface 62 that has a wavy contour. Slipper ring 64 is located radially inside outer ring 58 and radially outside shaft 14′. An outer radial surface 66 of slipper ring 64 has a wavy contour. A set of rollers 68 fit between the wavy contoured outer surface 66 of slipper ring 64 and the wavy contoured inner surface 62 of outer ring 58. Relative rotation between slipper ring 64 and outer ring 58 cause rollers 68 to move along the wavy contours such that rollers 68 push slipper ring 64 radially inward. Slipper ring 64 has a slit 70 that allows it to contract in response to these forces exerted by rollers 68 and grip shaft 14′, selectively coupling shaft 14′ to outer ring 58 and therefore to rotor 30′. When slipper ring 64 is circumferentially aligned with outer ring 58 such that rollers 68 fit in gaps formed by the wavy contoured surfaces, then slipper ring 64 expands to fit loosely around shaft 14′. In this condition, relative rotation between shaft 14′ and slipper ring 64 is possible with only slight parasitic drag. Slipper ring 64 has a notch 72 in outer radial surface 66 which is used to hold slipper ring 64 in this circumferentially aligned position as described in more detail below. In operation of slipper clutch assembly 52, the clutch of an electric axle (example shown in FIG. 1) is engaged by allowing relative rotation between slipper ring 64 and outer ring 58 and is disengaged by fixing the circumferential position of slipper ring 64 relative to outer ring 58 via notch 72.

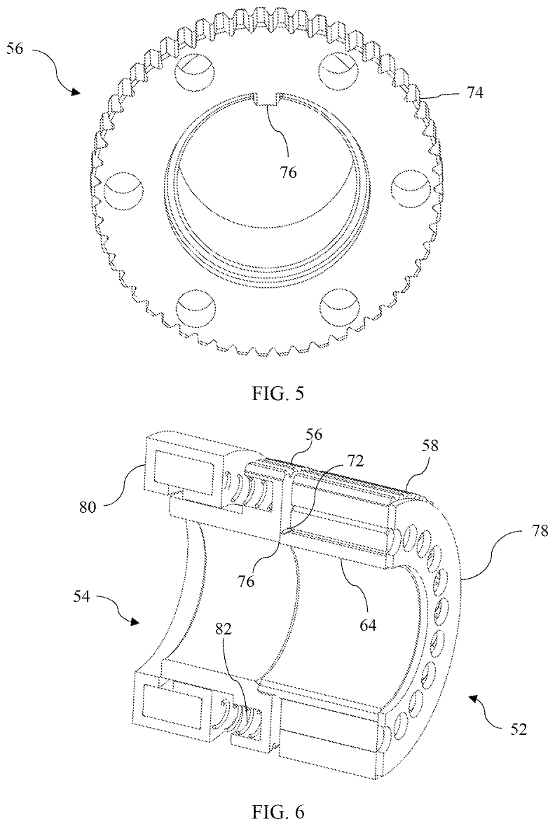

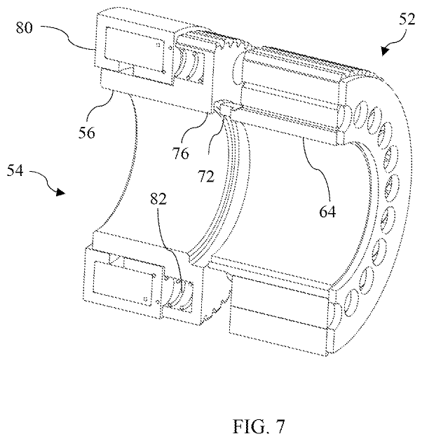

FIG. 5 shows the armature 56 of actuator assembly 54 in greater detail. This pictorial view shows the side facing toward slipper clutch assembly 52. Armature 56 has an outer radial surface with an external spline 74 which, like outer ring 58, meshes with an internal spline of rotor 30′. Unlike outer ring 58, however, armature 56 is supported to slide axially with respect to rotor 30′. Armature 56 includes a protrusion 76 extending radially inward from an inner radial surface of armature 56 configured to selectively engage notch 72 as explained in greater detail below with respect to FIGS. 6-7.

FIG. 6 is a cutaway view of slipper clutch assembly 52 and actuator assembly 54 in the disengaged state or position. End plate 78 restrains the slipper clutch assembly 52 from moving axially to the right with respect to rotor 30′. Solenoid 80 is fixed to housing 40. In the disengaged state, solenoid 80 is not energized and does not apply force to armature 56. Spring 82 biases armature 56 toward the slipper clutch assembly 52, causing protrusion 76 to engage notch 72 and align the circumferential position of slipper ring 64 with that of outer ring 58. In the disengaged state, the shaft 14′ is disconnected from outer ring 58 and rotor 30′.

FIG. 7 is a cutaway view of slipper clutch assembly 52 and actuator assembly 54 in the engaged state. The engaged state is achieved by energizing solenoid 80, causing solenoid 80 to exert an axial force on armature 56 to move, or pull, armature 56 in an axial direction away from slipper clutch assembly 52, overcoming the force exerted by spring 82. Protrusion 76 disengages from notch 72, permitting the slight relative rotation of slipper ring 64 which causes slipper ring 64 to grip shaft 14 selectively coupling shaft 14′ to outer ring 58 and therefore to rotor 30′.

In an alternative embodiment, not pictured, the slipper clutch assembly may include an inner ring fixed to the shaft and a slipper ring that expands radially to grip the rotor. In this case, the armature would be fixed for rotation to the shaft as opposed to the rotor.

In another alternative embodiment, the spring may bias the armature away from the slipper clutch assembly and the solenoid may be energized to force the armature toward the slipper clutch assembly into engagement with the slipper ring.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, to the extent any embodiments are described as less desirable than other embodiments or prior art implementations with respect to one or more characteristics, these embodiments are not outside the scope of the disclosure and can be desirable for particular applications.

### LIST OF REFERENCE CHARACTERS

10 two-motor electric axle drive
12 left gearbox input shaft
14 right gearbox input shaft
14′ shaft
16 left gearbox
18 wheel
20 left stator
22 rotor
24 right gearbox
26 right wheel
28 right stator
30 right rotor
30′ rotor
32 clutch
34 rotor disconnect unit
40 housing
44 bearing
46 bearing
48 bearing
50 input gear
52 slipper clutch assembly
54 actuator assembly
56 armature
58 outer ring
60 external spline
62 inner radial surface
64 slipper ring
66 outer radial surface
68 rollers
70 slit
72 notch
74 external spline
76 protrusion
78 end plate
80 solenoid
82 spring
14′ shaft
30′ rotor

What is claimed is:

1. A rotor shaft disconnect clutch assembly comprising:
a housing;
a rotor supported for rotation with respect to the housing;
a shaft supported for rotation with respect to the housing;
an outer ring fixed to the rotor and having a radially inner surface;
a slipper ring disposed radially between the outer ring and the shaft;
a plurality of rollers disposed between the radially inner surface of the outer ring and a radially outer surface of the slipper ring configured to radially compress the slipper ring in response to rotational displacement of the slipper ring relative to the outer ring;
an armature rotationally fixed to the rotor and configured to slide axially with respect to the rotor, the armature having a feature configured to selectively engage a feature of the slipper ring to rotationally position the slipper ring with respect to the outer ring; and
a solenoid fixed to the housing and configured to selectively exert an axial force on the armature.

2. The rotor shaft disconnect clutch assembly of claim 1, wherein the shaft is disengaged from the outer ring and the rotor when the feature of the armature is engaged with the feature of the slipper ring.

3. The rotor shaft disconnect clutch assembly of claim 2, wherein the shaft is coupled to the outer ring and the rotor when the feature of the armature is disengaged from the feature of the slipper ring allowing rotational displacement of the slipper ring relative to the outer ring.

4. The rotor shaft disconnect clutch assembly of claim 1, further comprising a spring configured to bias the armature toward the slipper ring such that the feature of the armature is engaged with the feature of the slipper ring.

5. The rotor shaft disconnect clutch assembly of claim 4, wherein in response to the solenoid exerting the axial force on the armature, the armature slides axially away from the slipper ring overcoming a force exerted by the spring to disengage the feature of the armature from the feature of the slipper ring thereby coupling the shaft to the outer ring and rotor.

6. The rotor shaft disconnect clutch assembly of claim 1, wherein the feature of the armature is a protrusion, the feature of the slipper ring is a notch, and the protrusion is configured to selectively engage with the notch.

7. The rotor shaft disconnect clutch assembly of claim 1, wherein the radially inner surface of the outer ring is designed as a wavy contoured surface.

8. The rotor shaft disconnect clutch assembly of claim 7, wherein the radially outer surface of the slipper ring is designed as a wavy contoured surface.

9. The rotor shaft disconnect clutch assembly of claim 1, the plurality of rollers are configured to fit in gaps formed by the wavy contoured surfaces when the slipper ring is circumferentially aligned with the outer ring.

10. A rotor shaft disconnect clutch assembly comprising:
a housing;
a rotor supported for rotation with respect to the housing;
a shaft supported for rotation with respect to the housing;
an outer ring fixed to the rotor and having a radially inner surface;
a slipper ring disposed radially between the outer ring and the shaft; and
an armature rotationally fixed to the rotor and configured to slide axially with respect to the rotor, the armature having a protrusion configured to selectively engage a notch of the slipper ring to rotationally position the slipper ring with respect to the outer ring.

11. The rotor shaft disconnect clutch assembly of claim 10, further comprising a spring configured to bias the armature toward the slipper ring such that the protrusion of the armature engages with the notch of the slipper ring.

12. The rotor shaft disconnect clutch assembly of claim 11, further comprising an actuator fixed to the housing and configured to selectively exert an axial force on the armature that overcomes a force exerted by the spring to slide the armature axially away from the slipper ring to disengage the protrusion from the notch to allow rotational displacement of the slipper ring relative to the outer ring to couple the shaft to the outer ring and rotor.

13. The rotor shaft disconnect clutch assembly of claim 12, wherein the actuator is a solenoid.

14. The rotor shaft disconnect clutch assembly of claim 10, further comprising a plurality of rollers disposed between the radially inner surface of the outer ring and the radially outer surface of the slipper ring configured to radially compress the slipper ring in response to rotational displacement of the slipper ring relative to the outer ring.

15. The rotor shaft disconnect clutch assembly of claim 14, wherein the slipper ring includes a slit configured to allow the slipper ring to contract in response to forces exerted by the rollers and grip the shaft to couple the shaft to the outer ring and the rotor.

16. The rotor shaft disconnect clutch assembly of claim 10, wherein the rotor is supported for rotation via first and second bearings disposed on axially opposite sides of the outer ring.

17. The rotor shaft disconnect clutch assembly of claim 10, wherein the outer ring includes an outer radial surface with an external spline configured to mesh with an internal spline of the rotor.

18. The rotor shaft disconnect clutch assembly of claim 10, wherein the protrusion extends radially inward from an inner radial surface of the armature.

19. The rotor shaft disconnect clutch assembly of claim 10, wherein the radially inner surface of the outer ring is designed as a wavy contoured surface and the radially outer surface of the slipper ring is designed as a wavy contoured surface.

20. The rotor shaft disconnect clutch assembly of claim 1, a plurality of rollers are configured to fit in gaps formed by the wavy contoured surfaces when the slipper ring is circumferentially aligned with the outer ring.
